(19) United States
(12) Patent Application Publication
(10) Pub. No.: US 2002/0176614 A1
(43) Pub. Date: Nov. 28, 2002

(54) Method and apparatus for navigation-supported, graphic presentation of position-dependent measured information of elongate body organs

(76) Inventors: Rainer Kuth, Herzogenaurach (DE); Martin Requardt, Nuernberg (DE)

Correspondence Address: SCHIFF HARDIN & WAITE, 6600 SEARS TOWER, 233 S WACKER DR, CHICAGO, IL, 60606-6473, US

(21) Appl. No.: 10/126,010

(22) Filed: Apr. 19, 2002

(30) Foreign Application Priority Data
Apr. 20, 2001 (DE) 10119454.4

(51) Int. Cl. G06F 17/00

(52) U.S. Cl. 382/128; 128/920

(57) ABSTRACT

A method for navigation-supported graphic presentation of position-dependent measured information of elongate body organs allows a selection as well as a variation of a position along the multi-dimensional course of a three-dimensional graphic reconstruction of an elongate organ by entry of a one-dimensional control signal and a simultaneous presentation of a section through this body organ at the selected position.

### BACKGROUND OF THE INVENTION

1. Field of the Invention

The present invention is directed to a method and to software for medical data processing for image-supported editing of information from data of medical procedures.

2. Description of the Prior Art

Modern medical analysis devices supplied three-dimensional data of the inside. of the body of a patient that modern methods of medical image processing convert into spatial presentations of the inside of the body. The three-dimensional, graphic presentations from the inside of the body resulting therefrom are an indispensable component part of medical diagnostics. With the assistance of segmenting methods, the medical professional can isolate relevant anatomical structures from the dataset that are of interest to him or her, such as, for example, nerves or fat tissue, bone-equivalent or muscle-equivalent tissue, or non-anatomical structures such as, for example, foreign bodies or implants. The result can be visualized in a three-dimensional, graphic reconstruction of the structure. An interpretation of these images requires a high degree of experience on the part of the viewer with respect to anatomical structures and requires a good three-dimensional presentation capability. This is particularly true for elongate body organs whose expanse in their longitudinal direction predominates over an expanse in other directions, similar to a hose. Examples of this are the intestines or blood vessels whose course represents a three-dimensional overall curve with multiple smaller curves in many directions. The trachea, the esophagus and some bones are also examples.

Diseases of these elongate body organs are usually systematic diseases that simultaneously exhibit pathologies at a number of locations of the organ. The examination of these pathologies therefore requires an examination of the graphic reconstruction of the body organ along the elongate course thereof from the observer. Organs such as, for example, the blood vessels or the intestines already change their alignment in space to a noteworthy extent over very short length segments, following the course of the organ requires great concentration on the part of the observer.

PCT Application WO 99/42977 discloses a method for generating a path through the inside of an elongate body organ on the basis of a three-dimensional, graphic reconstruction of this body organ. To this end, a path is formed from a sequence of a number of positions within the body organ, the positions being maximally spaced from the organ structure that surrounds them. An inside view can be generated for each position of the path such that a presentation of the inside views in the sequence of the positions on the path produces a virtual endoscopy of the elongate body organ.

A method for automatic calculation of flight paths for virtual endoscopy path wherein the course of the flight path is calculated such that it assumes a central course through the elongate organ is disclosed in David S. Paik, Christopher F. Beaulieu, R. Brooke Jeffry, Geoffry D. Rubin and Sandy Napel, Automated Path Planning for Virtual Endoscopy, Appendix to Medical Physics 25 (5): 629-637, May 1998.

In the rarest of instances, the individual segments of these body elements are oriented with reference to one of the body planes, so that the observer can generally not have recourse to the anatomical reference planes in the definition of a cross-sectional plane perpendicular to the course of the organ. The definition of a section plane at arbitrary positions of the body organ oriented with a defined line with respect to the course of an elongate body organ, however, can be implemented only with great outlay for a less experienced viewer and is not possible at all in many instances.

Exactly oriented-section planes, however, are of elementary significance for the evaluation of a pathology. Thus, for example, a precise measurement of the vessel diameter at a selected zone requires an exact alignment of the section plane perpendicular to the course of the vessel at this position. Since most blood vessels curve in a larger variety of spatial directions overtheir course, aligning the section plane exactly perpendicular to the respective course of the vessel at all desired positions. always represents a demanding requirement for a viewer. In general, a deviation from the ideal cross-sectional plane that is not inconsiderable must therefore be accepted.

### SUMMARY OF THE INVENTION

It is an object of the present invention to provide a method and a computer software product that enables a less experienced viewer of three-dimensional medical image datasets to generate a diagnostically relevant, two-dimensional presentation of a selectable examination zone from these datasets with little outlay.

This object is achieved in a method, software and an apparatus for graphic presentation of location-dependent measured information of elongate body organs dependent on a position selected in a three-dimensional, graphic reconstruction of an elongate body organ structure, wherein a position along the multi-dimensional course of the elongate body organ can be selected by entering a one-dimensional control signal, and at least one section at the selected position is displayed through the elongate body organ as measured information of the elongate body organ allocated position-dependently to this position.

The navigation along a complex, three-dimensional, elongate structure is thus advantageously reduced to the input of a relative variation of the position at this structure. In order, for example, to proceed from a position at a blood vessel to a second position at this blood vessel, a viewer need only specify the length of the path that separates the first position from the second position on the blood vessel as well as, implicitly, the relative direction of the position variation with reference to the course of the organ. The calculation of the spatial attitude of the second position ensues automatically with the system on the basis of the entered length and relative direction, of the path and the course of the organ. As a result of the automatic display of a sectional view through the appertaining organ at the selected position, the internal structure of the organ is simultaneously apparent to the viewer in addition to the external form of the organ under examination.

The illustrated section preferably is orthogonal to the course of the elongate body organ at the selected position, so that the cross-section of the organ is available at every position of the organ. Alternatively, the section plane can ensue at the selected position parallel to an anatomical reference plane or axially thereto, or the section plane can be selected by defining at least one further position along the course of the elongate body organ and/or can be freely selected, so that a vessel section around the current position is optimally acquired in conformity with the observer's requirements.

In a further embodiment of the present invention, the position is selected along an imaginary central axis of the elongate body organ. This allows navigation along a geometrical characteristic that is always present in elongate body organs and that is simultaneously independent of any and all current configuration of these body organs. Also advantageously, the one-dimensional control signal that has been entered is visualized by a presentation of a virtual slide at an elongate, straight graphic element, so that the viewer is provided with a simple, linear possibility for entering a one-dimensional control signal. Advantageously, the variation of the position at the course of the elongate body organ is proportional to the one-dimensional control signal that has been entered, so that the viewer is provided with a direct correlation between the input of a control signal and the corresponding change in position. Also advantageously, the variation of the position over the course of the elongate body organ can be non-linearly dependent on the one-dimensional control signal that has been entered. This is especially advantageous when short paths on the appertaining organ must be traversed with good position but very long paths must also be very quickly traversed at the same time. The one-dimensional control signal can be entered with a scroll device of a pointer device, so that the pointer device itself need not be moved.

Advantageously, a tube is approximated at the elongate body organ, this making it possible for the viewer to more precisely analyze the configurations of the subject matter of the examination. It is especially advantageous if the elongate body organ is a blood vessel.

The apparatus for graphic presentation of position-dependent measured information of elongate body organs has an input interface that calculates the one-dimensional control signal from various user inputs such as, for example, the movement of a computer mouse or the pressing of specific keys of a keyboard or, respectively, of a specific input device. In a preferred embodiment of the invention, the data for spatial reconstruction of the body element are requested via the data networking mechanism of the apparatus, so that the current data can always be fetched from their standard storage locations.

The described method is preferably employed in imaging medical diagnostics. Since the method requires a comparatively low calculating outlay, it is faster then virtual endoscopy and has the additional advantage that it only the interior of a hollow organ but also, in parallel with, the environment thereof that can be examined.

### DESCRIPTION OF THE DRAWINGS

FIG. 1 is a schematic 3D illustration of the inventive method in the field of imaging medical diagnostics.

FIG. 2 is a flowchart of an inventive function sequence

FIG. 3 is a block circuit diagram of the components of a specific embodiment of the present invention.

### DESCRIPTION OF THE PREFERRED EMBODIMENTS

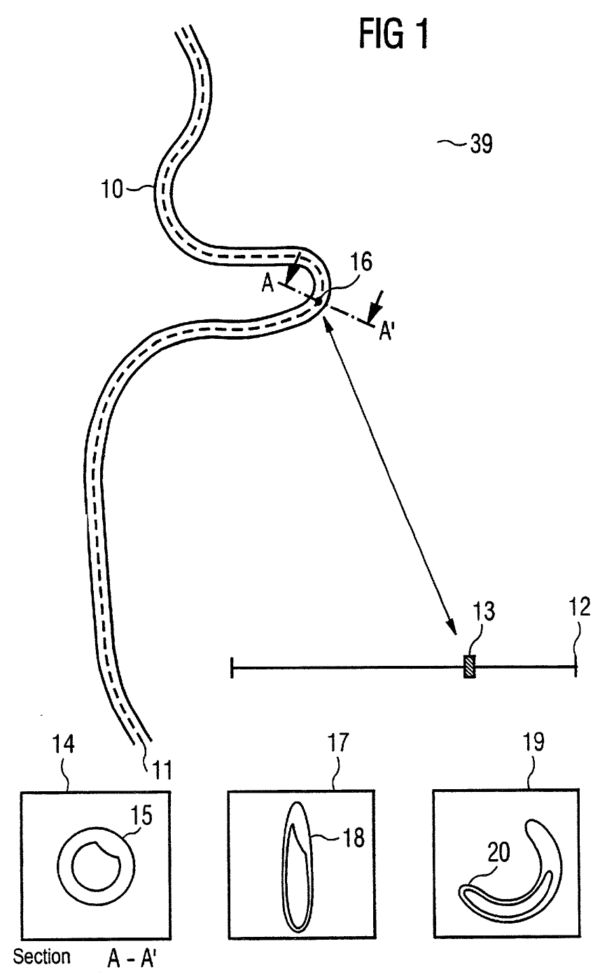

FIG. 1 is an illustration of an elongate body organ 10 as acquired with a standard imaging method of medical data processing. Elongate body organs are particularly found in the human body in the region of the respiratory paths, in the gastrointestinal track, as bones and, above all, in the vascular system. Blood vessels in particular are generally characterized by curvatures in a large variety of spatial directions over a short length. Diseases of the vascular system are usually systematic diseases having several pathologies occurring simultaneously at different locations of the system. Diagnostics of systematic diseases are therefore not limited to the investigation of a single peculiarity but extend generally over a wide range of a vessel structure. This means that the viewer must follow the course of the blood vessel in its three-dimensional graphic reconstruction in the examination. This not only requires a high level of experience in the viewing of anatomical structures but also requires an excellent three-dimensional comprehension.

As shown in FIG. 1, the present invention offers a less experienced viewer a simple possibility of examining a blood vessel or, in general, any elongate body organ along its course. To this end, the imaginary central axis 11 of the elongate anatomical structure 10 is first calculated. For an ideally annular organ, the ideal central axis 11 proceeds exactly centrally in the anatomical structure 10. In the case of deviations from the ideally annular cross-section, the position of the imaginary central axis 11 is selected such that it exhibits the largest possible central spacing from the walls of the organ 10.

The imaginary central axis 11 can extend along the entire length of the organ 10. The user, however, can limit this axis 1 to a sub-section of the organ 10 for the examination, so that the imaginary central axis 1 in this case is only calculated for this selected sub-region. For aiding the visual comprehension of the viewer, the imaginary central axis 11 can be displayed within the elongate body organ 10.

With the imaginary central axis 1 1 displayed, the viewer can easily recognize the course of the body organ; particularly given a highly convoluted course, however, it is not simple to move in the three-dimensional space along this course. The viewer is therefore given a simple possibility of determining and modifying the position along the imaginary central axis 11. To this end, an elongate, straight graphic object 12, for example a running rail or a slide rail, is mixed in on the display device 39. The operators of a linear image are now defined, so that each point on the straight, elongate, graphic element 12 corresponds exactly to one position on the imaginary central axis 11. A further graphic element 13 having comparatively small geometrical dimensions in relationship to the graphic element 12 is displayed on the elongate graphic element 12. The graphic element 13 has the function of a slide whose position on the strip 12 can be displaced with a pointer device such as, for example, a mouse pointer. When the viewer modifies the position of the slide 13 on the strip 12 with the assistance of a pointer device, the viewer correspondingly changes its position 16 in the organ 10, or, more specifically, on the imaginary central axis 11.

In the simplest case, the variation of the position at the imaginary central axis 11 is proportional to the path length by which the slide 13 was displaced on the strip 12. This conveys to the user the feeling of directly controlling the navigation along the central axis 11 and is especially advantageous when the relative position changes cover smaller through moderate distances.

When examining systematic diseases in blood vessel systems, that pathologies are often found at sections of the vessel that are at a large distance from one another. In order to bridge the distance between two positions lying far apart in a reasonable time, the displacement of the slide 13, and thus the variation of the position at the imaginary central axis 11, can ensue with an interpretation of the control signal, instead of linearly.

When, for example, the mouse pointer is clicked laterally next to the slide 13, then the slide 13, with the input key of the pointer device pressed, moves on the slide 12 onto the position of the mouse pointer without having to change the position of the mouse pointer itself. So-called ballistic factors thus can also be defined, so that the change in position ensues all the faster the farther the slide is from the mouse pointer, or the longer one of the input keys of the pointer device is kept pressed.

The control signal for changing the position also can be entered by the viewer placing the pointer device at a suitable edge of the display region and activating it. Particularly when a sub-section of the elongate anatomical structure under examination is shown on the display device, a region of interest to the viewer in enlarged form for examination. Alternatively, the motion can be initiated by clicking one of the ends of the strip 12.

Modern pointer devices offer scroll mechanisms, for example in an embodiment of a wheel or knurled wheel that, dependent on the embodiment, supply a separate, linear output signal by turning or stressing in one direction or at one location. The output signal of such a scroll mechanism can be employed as control signal for varying. the position since a movement or displacement of the pointer device itself is thereby eliminated.

Diseases of elongate organs can be evaluated best on the basis of sectional views of the affected regions. In a specific embodiment of the invention, a sectional view allocated to the selected position is therefore offered to the observer at every selected position. A modification of the position at the organ is followed immediately by an updating of the sectional view.

In angiography as well as in phlebography, the identification of the vessel cross-section is of great significance. This is particularly true of flow measurements, since it is not the volume stream of the blood through the vessel but only the velocity with which the blood flows through the vessel that can be identified with the known measuring methods. The volume stream derives therefrom as integral of the flow rate of the blood overtime multiplied by the vessel cross-sectional area thereof. An exact identification of the vessel cross-sectional area at the selected position assumes that the sectional area is aligned exactly perpendicularly to the direction of the blood vessel at this position. Since most vessels curve in the greatest variety of spatial directions, it is not simple for a diagnostician to place the plane of section exactly perpendicular to the course of the vessel at the selected position. In general, greater deviations from the ideal, perpendicular cross-section therefore will have to be accepted.

In the present invention, the course of the blood vessel 10 is simulated by the calculation of the imaginary central axis 11. A mathematical function for describing the geometry of the blood vessel in its elongate expanse is thus available, with whose assistance the corresponding direction of the blood vessel at every position can be calculated and from which the cross-sectional perpendicular thereto can be identified.

With the present invention, it is also possible for a less experienced viewer to examine elongate body organs with little outlay, since a navigation along the course of the organ is reduced to a linear displacement of a slide element 13 and a section perpendicular to the present direction of the organ at the selected position is presented in real time, only limited by the performance capability of the system.

Errors that can arise due to a manual setting of a cross-sectional plane are thereby precluded. This is of great significance particularly for the field of stenosis validation, since the position at which the determination of the volume flow of the blood through the vessel is made is directly proportionally limited by the position of the defining cross-sectional area of the vessel. An exactly defining cross-sectional area, however, assumes a section exactly perpendicular through the blood vessel, as assured in the present invention.

Also advantageously, high resolution measurements with medical scanners can be undertaken at patients based on the calculated sections proceeding perpendicular to the vessel in order to obtain a more precise image of the pathogenic region.

In another embodiment of the invention, the viewer is offered the possibility of selecting between orientations of the section planes. Instead of a section perpendicular to the course of the body organ, for example, the viewer can select an orientation of the plane of section through the selected position parallel to one of the anatomical reference planes 18, or in the direction of a body axis, limb axis or organ axis 18. Corresponding to this selection, the viewer is then presented with a coronal, sagittal, transverse or axial section through the current position in the body organ.

A pathogenic region is not always shaped such that it can be optimally imaged for a diagnostic evaluation by means of one of the section orientations that have been described. According to the present invention, the viewer is therefore presented with the possibility of defining the orientation of the section plane as the viewer deems fit, by the viewer defining one or more reference points different from the current position on the imaginary central axis and/or further points at arbitrary locations in space for defining the section plane.

In a preferred embodiment of the present invention, the viewer can initiate a simultaneous presentation of a number of the above-described types of section 14, 17, 19 on the display device. This aids a visual coverage of an examination region by means of the presentation of the subject from various observation angles.

Since every medical method represents other data relevant for a pathology, a diagnostician is extremely interested in integrating the data of a number of modalities such as, for example, computed tomography, magnetic resonance and ultrasound data in a single presentation. According to a further embodiment of the invention, the three-dimensional, graphic reconstruction of the elongate body organ can be employed for the integral presentation of all modalities. These data can be of a graphic nature, for instance the mixing-in of a vessel cross-section, but can also be non-graphic data such as, for example, the value of a flow measurement at the corresponding location of the body organ at which it was identified. By combining the data from various procedures, for example, the relevant data for a pathology can be linked to the graphic presentation of the body organ and can be displayed along the course thereof. Some of these data can be permanently displayed with the body organ in their allocation to a specific position of the body organ; others only become visible when the corresponding position is selected.

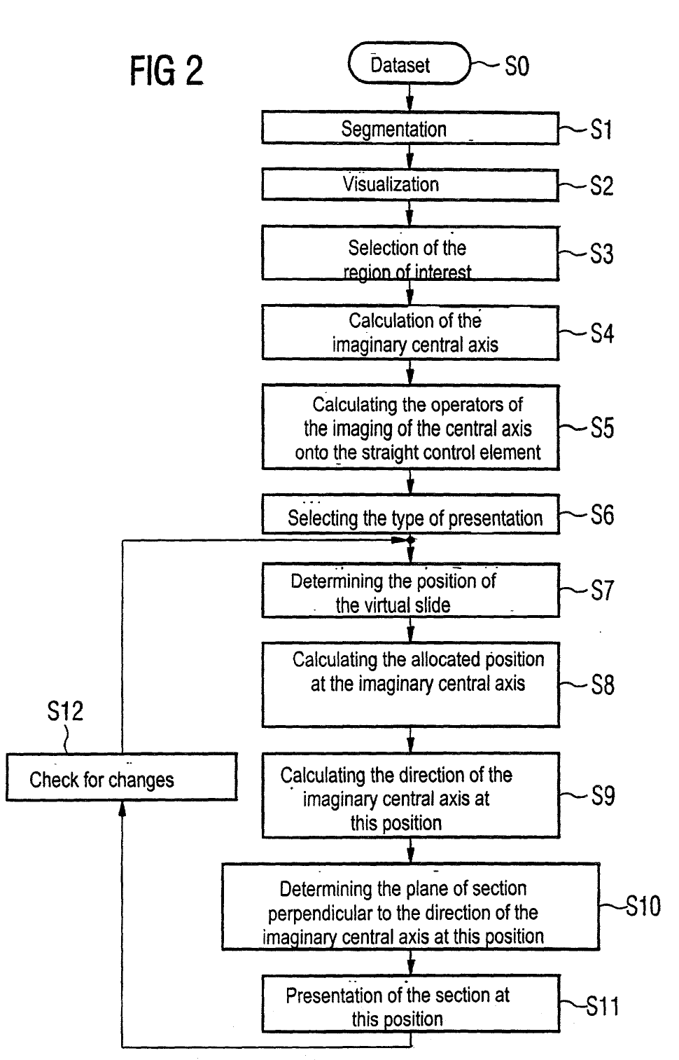

In a flowchart, FIG. 2 shows the function sequence of the present invention in an elementary form. Proceeding from the dataset of a medical procedure in Step SO, a segmentation of the desired anatomical structure is undertaken in Step SI and is visually presented in Step S2. In Step S3, the user then defines the section of interest to the user at the three-dimensional reconstruction of the anatomical structure. Subsequently in Step S4, the imaginary central axis of the elongate anatomical structure is calculated. Advantageously, the imaginary central axis is implemented as a spline curve, resulting in the quantity of data for the production thereof being kept low. For example, Bezier curves or NURBS (non-uniform ration B-spline) can be employed as splines. In the next step S5, the operators for an imaging of the imaginary central axis 11 onto the straight, oblong graphic object 12 are calculated. When the user wishes to undertake a specific type of presentation 14, 17,19 of the location-dependent parameters, this possibility is made available to the user in Step S6. In Step 7, the current position of the slide 13 is interrogated and the allocated position at the imaginary central axis is calculated therefrom in Step S8. In Step S9, the direction of the imaginary central axis 11 at this position 16 is calculated for that case wherein section the plane perpendicular to the direction of the imaginary axis 11 was selected at the current position 16. Subsequently, the section plane perpendicular to the direction of the imaginary central axis 11 at this position 16 is identified. When the user selects some other or one or more additional sectional views, the section plane through the position 16 is defined according to the prescriptions additionally or alternatively thereto in Step 10. In Step S11, the section or sections 15, 18, 20 through the anatomical structure are presented 14, 17, 19 according to the previously selected section orientations. In the next Step S12, a check is carried out to determine whether the user has, for example, requested changes in the presentation mode via a menu. For example, the user has the possibility of undertaking a change of the region of interest to the user, but also has the possibility of modifying the type of sectional presentation or of requesting other data of other modalities for the presentation. When change requests are present, they are now implemented. In both instances, i.e. given the presence or the absence of change requests on the part of the user, the current position of the virtual slide 13 is subsequently interrogated, so that the Steps S7 through S12 repeat in a loop.

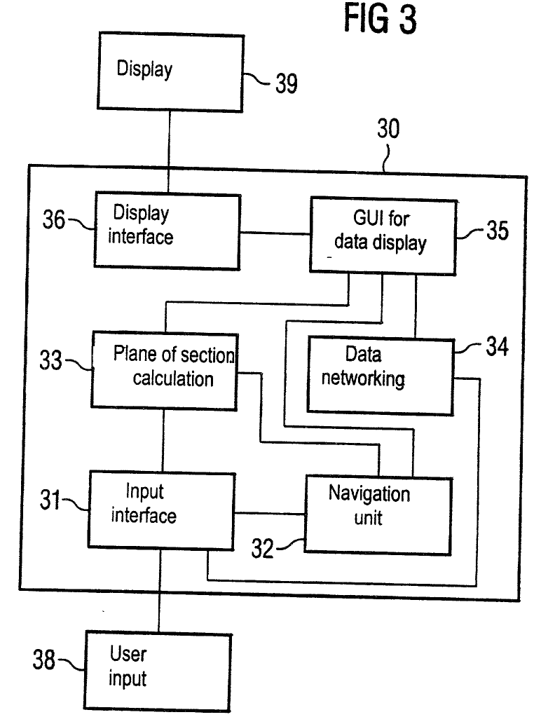

FIG. 3 shows the basic components of the invention in a block circuit diagram. The inventive apparatus is embedded in a program-processing part 30 of a medical data processing device for imaging medical data processing having a device for user inputs 38 and a display device 39. The inventive apparatus has a device 31 that functions as interface for input signals from the user input device 38 and extracts instructions of the user and control signals from these signals for the selection of a position on the presentation of the elongate anatomical structure. In the navigation unit 32, the control signals received from the input interface 31 are employed in order to calculate the position of the slide presentation 13 on the display 39. Further, the navigation unit 32 is responsible for the calculation of the imaginary central axis 11 and for the calculation of a position on the imaginary central axis corresponding to the current position of the slide 13. For visualizing the selected position 16 on the central axis, the calculated data are forwarded to the graphic user interface 35. These data are likewise employed by the device 33 for the calculation of the planes of section, forming the basis therein together with the instructions edited from the user interface 31 for calculations of the requested planes of section and through the anatomical structure. The result of this calculation is in turn forwarded to the graphic user interface 35 for preparing the presentation on the display 39. The simultaneous presentation of the data of other modalities is realized via the data networking unit 34. This can also be employed for introducing the dataset of the anatomical structure into the system. The data generated by the graphic user interface 35 are edited such by the display interface 36 that a graphic presentation of the data on the display 39 is enabled.

The invention allows a less experienced viewer of three-dimensional reconstructions of elongate anatomical structures to make a precise analysis of the image material given little outlay. The comfortable presentation of a dataset from medical procedures as three-dimensional image that already makes concessions to the optical comprehension of a viewer is supported by the present invention on the basis of a simple, uncomplicated navigation along the imaged organ.

Although modifications and changes may be suggested by those skilled in the art, it is in the intention of the inventors to embody within the patent warranted hereon all changes and modifications as reasonably and properly come within the scope of their contribution to the art.

We claim as my our invention:

1. A method for graphic presentation of position-dependent measured information of elongate body organs, comprising the steps of:
displaying a three-dimensional graphic reconstruction, on a computerized display system, of an elongate body organ structure based on measured information, said elongate body organ structure having a multi-dimensional course;
selecting a position along said multi-dimensional course of said elongate body organ by entering a one-dimensional control signal into said computerized display system; and
upon entry of said control signal, displaying a selected portion of said measured information dependent on said position, including displaying a section through said elongate body organ structure at said position.

2. A method as claimed in claim 1 comprising automatically displaying said section as a section proceeding orthogonally to said course of said elongate body organ structure at said position.

3. A method as claimed in claim 1 comprising automatically displaying said section as a section through said elongate body organ at said position parallel to an anatomical reference plane.

4. A method as claimed in claim 1 comprising displaying said section as a section through said elongate body organ at said position parallel to an selected axis.

5. A method as claimed in claim 1 wherein said section is a first section and wherein said position is a first position, and comprising the additional step of entering, into said computerized display system, a length from said first position along said course of said elongate body organ structure and displaying at said computerized display system a second section through said elongate body organ structure at a second position coinciding with an end of said length.

6. A method as claimed in claim 1 wherein said section is a first section and wherein said position is a first position, and comprising the additional step of entering, into said computerized display system, an arbitrary second position along said course of said elongate body organ structure, and displaying at said computerized display system a second section through said elongate body organ structure at said second position.

7. A method as claimed in claim 1 comprising calculating, in said computerized display system, an imaginary central axis proceeding within said elongate body organ structure along said course of said elongate body organ structure, and selecting said position along said imaginary central axis.

8. A method as claimed in claim 1 comprising displaying a virtual slide as an elongate, straight graphic element on said computerized display system, and entering said one-dimensional control signal by moving said slide to a selected position within said elongate, straight graphic element.

9. A method as claimed in claim 1 wherein said computerized display device has a pointer device, and wherein the step of entering said one-dimensional control signal comprises displaying a scroll device of said pointer device at said computerized display device and entering said one-dimensional control signal by operating said control device with a pointer of said pointer device.

10. A method as claimed in claim 1 comprising modifying said position of said section along said course of said elongate body organ structure proportionally to said one-dimensional control signal.

11. A method as claimed in claim 1 comprising modifying said position of said section along said course of said elongate body organ structure non-linearly depending on said one-dimensional control signal.

12. A method as claimed in claim 1 comprising approximating said elongate body organ structure from said measured information as a tube structure, and displaying said tube structure as said three-dimensional graphic reconstruction of said elongate body organ structure.

13. A method as claimed in claim 1 comprising displaying a three-dimensional graphic reconstruction of a blood vessel as said elongate body organ structure.

14. A computer software product for graphic presentation of position-dependent measured information of elongate body organs, said computer software product, when loaded into a computerized display system allowing display of a three-dimensional graphic reconstruction, on the computerized display system, of an elongate body organ structure based on measured information, said elongate body organ structure having a multi-dimensional course, and allowing selection of a position along said multi-dimensional course of said elongate body organ by entering a one-dimensional control signal into said computerized display system, and upon entry of said control signal, causing a selected portion of said measured information to be displayed dependent on said position, including a section through said elongate body organ structure at said position.

15. A computer software product as claimed in claim 14 which automatically displays said section as a section proceeding orthogonally to said course of said elongate body organ structure at said position.

16. A computer software product as claimed in claim 14 which automatically displays said section as a section through said elongate body organ at said position parallel to an anatomical reference plane.

17. A computer software product as claimed in claim 14 which displays said section as a section through said elongate body organ at said position parallel to an selected axis.

18. A computer software product as claimed in claim 14 wherein said section is a first section and wherein said position is a first position, and wherein said computer software product allows an entry into said computerized display system of a length from said first position along said course of said elongate body organ structure and displays at said computerized display system a second section through said elongate body organ structure at a second position coinciding with an end of said length.

19. A computer software product as claimed in claim 14 wherein said section is a first section and wherein said position is a first position, and wherein said computer software product allows entry into said computerized display system, an arbitrary second position along said course of said elongate body organ structure, and displays at said computerized display system a second section through said elongate body organ structure at said second position.

20. A computer software product as claimed in claim 14 which calculates an imaginary central axis proceeding within said elongate body organ structure along said course of said elongate body organ structure, and selecting said position along said imaginary central axis.

21. A computer software product as claimed in claim 14 which displays a virtual slide as an elongate, straight graphic element on said computerized display system, and allows entry of said one-dimensional control signal by moving said slide to a selected position within said elongate, straight graphic element.

22. A computer product software as claimed in claim 14 wherein said computerized display device has a pointer device, and wherein said computer software product, for entering said one-dimensional control signal, displays a scroll device of said pointer device at said computerized display device and allows entry of said one-dimensional control signal by operating said control device with a pointer of said pointer device.

23. A computer software product as claimed in claim 14 which modifies said position of said section along said course of said elongate body organ structure proportionally to said one-dimensional control signal.

24. A computer software product as claimed in claim 14 which modifies said position of said section along said course of said elongate body organ structure non-linearly depending on said one-dimensional control signal.

25. A computer software product as claimed in claim 14 which approximates said elongate body organ structure from said measured information as a tube structure, and displays said tube structure as said three-dimensional graphic reconstruction of said elongate body organ structure.

26. A computer software product as claimed in claim 14 which displays a three-dimensional graphic reconstruction of a blood vessel as said elongate body organ structure.

27. An apparatus for graphic presentation of position-dependent measured information of elongate body organs, comprising:
a memory containing measured information representing an elongate body organ structure having a multi-dimensional course;
a data networking device having access to said memory for obtaining said measured information;
a navigation device connected to said data network device for calculating, from said measured information, a position in said elongate body organ structure dependent on a one-dimensional control signal; and
a graphic user interface connected to said navigation device including a section calculator for calculating a section of said elongate body organ structure from said measured information dependent on said position and for displaying a three-dimensional graphic reconstruction of said elongate body organ structure together with said section.

28. An apparatus as claimed in claim 27 further comprising an operator input unit connected to said section calculator and said navigation unit allowing entry of said one-dimensional control signal by an operator.

29. An apparatus as claimed in claim 27 wherein said data network device requests said data for formulating said three-dimensional reconstruction of said body organ structure from a remote storage location.
